(19) United States
(12) Patent Application Publication
(10) Pub. No.: US 2025/0333023 A1
(43) Pub. Date: Oct. 30, 2025

(54) METHOD AND SYSTEM FOR REGULATING THE PRESENCE OF CONDENSATION ON AT LEAST ONE GLAZED UNIT OF A VEHICLE

(71) Applicant: SAINT-GOBAIN GLASS FRANCE, COURBEVOIE (FR)

(72) Inventors: Xuejuan XU, COURBEVOIE (FR); Guillaume PANDRAUD, COURBEVOIE (FR)

(21) Appl. No.: 18/864,319

(22) PCT Filed: Apr. 27, 2023
(86) PCT No.: PCT/EP2023/061164

§ 371 Date: Nov. 8, 2024

(30) Foreign Application Priority Data
May 9, 2022 (FR) 2204381

(51) Int. Cl. B60S 1/02; B60H 1/00

(52) U.S. Cl. CPC B60S 1/023; B60H 1/0073; B60H 1/00764; B60H 1/00785; B60H 1/008

(57) ABSTRACT

A method for regulating the presence of condensation on the inner surface of at least one glazed unit of a vehicle includes a control loop including obtaining at least one signal, referred to as a control signal, associated with a quantity and including past values and a current value of the quantity, a risk of moisture condensation on the inner surface of the at least one glazed unit that may be determined from the at least one quantity, determining, using the at least one control signal, a predictive command for at least one actuator of the vehicle so as to maintain or lower the risk below a threshold value, transmitting the predictive command to the at least one actuator.

### PRIOR ART

The present invention belongs to the general field of managing the state of one or more vehicle glazed units, such as cars, trucks, buses, trains and the like. It relates more particularly to a method for regulating the presence of condensation on at least one glazed unit of a vehicle. It also relates to a system configured to implement said method. The invention finds a particularly advantageous, although in no way limiting application, in the case of a vehicle including at least one electric motor in order to move, for example an electric or hybrid vehicle.

Managing the risk of moisture condensation, and therefore a fortiori the presence of condensation, on the inner surface of the windshield of a vehicle is of particular importance in terms of the safety of the users of said vehicle. Indeed, the presence of condensation on the windshield has a direct influence on the visual comfort of the driver of the vehicle, as it is expected that the driver has a field of view that is broader and as clear as possible in order to avoid any visual impairment/fatigue that would be detrimental to the safety of driving said vehicle.

In practice, managing this risk of condensation may prove complex insofar as it is likely to conflict with the management of thermal comfort within the passenger compartment, which is traditionally defined as a combination between, in particular, the temperature felt by the user or users of the vehicle, being expected that this temperature reaches a given value (for example, a temperature determined by the driver) within said passenger compartment, and the relative or absolute humidity within said passenger compartment.

Indeed, to achieve a given thermal comfort, use is traditionally made of a climate control system, also called an HVAC system (which stands for “Heating, Ventilation and Air Conditioning”) making it possible to heat, cool and ventilate the air circulating within the passenger compartment.

However, in many current vehicles, this HVAC system is also used to manage the risk of condensation on the windshield, to the point that the windshield has even priority over managing thermal comfort. This can therefore lead to problematic situations, such as for example in winter where the HVAC system cannot be used to manage the risk of condensation without introducing cold air and/or activating a cooling circuit, which then leads to a degradation of thermal comfort, or even an increase in the consumption of electrical energy on board the vehicle.

To overcome this difficulty, it has been proposed to equip the windshield with dedicated heating means (for example, resistive elements of the metal wire or strip type, heating interlayer of a laminated glazed unit, etc.).

Such heating means make it possible to efficiently defog the windshield, which is actually being heated directly with a low loss of heat in its vicinity, making it possible to increase the margin of operation in terms of optimizing the thermal management of the passenger compartment.

That being the case, said heating means are generally controlled by an on/off switch, operated by a user of the vehicle (for example, the driver of the vehicle). This use of the heating means cannot therefore be considered to be satisfactory since it results from a deliberate action of the user, that is an action based on a subjective criterion. Thus, sometimes the heating means may be left on because the user simply forgot, which certainly has a negative impact in terms of energy consumption.

One way of trying to overcome these disadvantages consists in particular of automatically controlling the management of the condensation on the windshield of the vehicle. Such automatic control is often carried out by means of a closed control loop using data coming from temperature and/or humidity sensors. On the basis of these data, the heating means are controlled by attempting to reduce the risk of condensation on the windshield.

Current solutions proposing automatic control in a closed loop rely on traditional PID-type regulation techniques (which stands for “proportional, integral, derivative”), and have proven to be ultimately unsatisfactory since they are not very conducive to a reliable evaluation of the risk of condensation on the windshield of the vehicle, nor to precise regulation thereof.

It should be noted that all of the elements set out above are definitively applied for any type of glazed unit of a vehicle, and therefore in particular for glazed unit other than a windshield (for example, a rear window, side window, etc.).

### OVERVIEW OF THE INVENTION

The present invention aims to remedy all or part of the disadvantages of the prior art, in particular those described above, by proposing a solution that makes it possible to automatically regulate (control) the presence of condensation on one or more glazed units of a vehicle, in a way that is more accurate and efficient than prior art solutions.

To this end, and according to a first aspect, the invention relates to a method for regulating the presence of condensation on the inner surface of at least one glazed unit of a vehicle, said method including a control loop comprising, during a current iteration, steps of:
obtaining at least one signal, referred to as a “control signal”, associated with a quantity and including past values and a current value of said quantity, a risk of moisture condensation on the inner surface of said at least one glazed unit that may be determined from said at least one quantity,
determining a predictive command for at least one actuator of the vehicle so as to maintain or lower said risk below a threshold value, said command being determined by means of a predictive model of said risk using said at least one control signal,
transmitting the predictive command to said at least one actuator.

The term “predictive command” refers here to a command aimed at activating/deactivating the heating and/or activating/deactivating at least one component belonging to the air-conditioning system so as to regulate the presence of condensation on said at least one glazed unit.

It should be noted that the expression “regulate the presence of condensation on said at least one glazed unit” covers several cases, namely:
the cases where no condensation is already present on said at least one glazed unit, in which case the regulation in question aims to prevent the appearance of condensation,
the cases where condensation is already present on said at least one glazed unit, in which case the regulation in question aims to eliminate it.

Furthermore, and more particularly, the term “predictive” refers to a command of the proactive compensation/correction type. Such a predictive command relates to an advanced automatic command technique (the acronyms “MPC” or “MBPC” are commonly used to refer to this technique, and stand for “Model (Based) Predictive Control”).

In its general principle, an MPC technique consists in using at least one model powered by signals. Said at least one model makes it possible to describe the change in one or more quantities, including in particular quantities associated with the signals that are provided at the input of said at least one model, in order to anticipate the future change of the quantities in question, and thus to predict which are the most appropriate commands to be transmitted based on this change.

The implementation of such an MPC technique is particularly suitable for the application envisaged here, that is the regulation of the presence of condensation on said at least one glazed unit of the vehicle. Indeed, the MPC technique makes it possible to create a proactive effect with respect to the control signals, so as to be able to generate regulation commands adapted to the change (over a determined future time horizon) in the quantities associated with the control signals.

It also makes it possible to avoid excessive variations of the handled quantities (i.e. the predictive command is gentler), which contributes to better use of the actuators (heating means, air conditioning system).

Ultimately, the implementation of the regulating method according to the invention advantageously makes it possible to finely regulate the presence of condensation on said at least one glazed unit, so as to particularly minimize the risk of the appearance of condensation, or else if condensation is already present, to favor a rapid removal thereof for driving safety reasons.

In particular embodiments, the regulating method may further comprise one or more of the following features, taken in isolation or in any of the technically possible combinations.

In particular embodiments, a plurality of control signals are obtained, including:
a signal whose associated quantity is a temperature of said at least one glazed unit, and
a signal whose associated quantity is an absolute humidity within the passenger compartment of the vehicle.

In particular embodiments, a single control signal is obtained, the quantity associated with said control signal being a relative humidity inside the vehicle in the vicinity of said at least one glazed unit.

“In the vicinity of said at least one glazed unit” refers here to a gap at the windshield of the order of a few millimeters, for example less than or equal to 10 mm.

In particular embodiments, the determination of said risk of condensation, by the predictive model and for a given time interval of a future time horizon, includes:
obtaining a temperature of said at least one glazed unit and of a dew point of the passenger compartment,
calculating a gap between said temperature of said at least one glazed unit and said dew point of the passenger compartment,
comparing said gap with at least one given value.

In particular embodiments, the determination of said risk of condensation, by the predictive model and for a given time interval of a future time horizon, includes:
obtaining a relative humidity inside the vehicle in the vicinity of said at least one glazed unit,
comparing said relative humidity with at least one given value.

In particular embodiments, said at least one actuator includes means for heating said at least one glazed unit and/or at least one actuator of an air-conditioning system of the passenger compartment of the vehicle from: a fan, a compressor, a heating resistor, an air recirculation flap.

In particular embodiments, the predictive model is configured to model:
the change in temperature and humidity conditions at the inner surface of said at least one glazed unit, and
the change in temperature and humidity conditions within the passenger compartment of the vehicle due to the operation of an air-conditioning system of said passenger compartment.

In particular embodiments, the regulating method also includes a step of obtaining at least one signal, called a “disturbance signal”, associated with a quantity and including past values and a current value of said quantity, said at least one disturbance signal being at least one of:
a signal whose associated quantity is a number of persons in the vehicle,
a signal whose associated quantity is a carbon dioxide level present in the passenger compartment,
a signal whose associated quantity is a vehicle speed,
a signal whose associated quantity is a temperature outside the vehicle,
a signal whose associated quantity is a relative or absolute humidity outside the vehicle,
a signal whose associated quantity is a weather forecast item of data,
a signal whose associated quantity is a solar power absorbed by said at least one glazed unit and/or by the passenger compartment of the vehicle. The regulating method further includes a step of determining, from said at least one disturbance signal, at least one predicted value of the quantity associated with said at least one disturbance signal,
the predictive model of said condensation risk also using said at least predicted value when determining the predictive command of said at least one actuator.

Such provisions advantageously make it possible to take into consideration measurable disturbances likely to affect the predictive command. This therefore results in a very high reactivity, in terms of regulation, with respect to conditions external to the vehicle, but also a possibility of refining (i.e. enriching) the predictive model, and therefore a fortiori increasing the accuracy of the regulation.

In particular embodiments, the step of determining the predictive command includes an optimization of a cost function including at least one term among:
a difference between the condensation risk predicted by the predictive model and said threshold value,
a rate of change in the condensation risk.

In particular embodiments, the cost function also includes a weighting of at least one term representative of a vehicle usage criterion, said at least one usage criterion including at least one of:
a criterion relating to an absence of frost on said at least one glazed unit,
a criterion relating to thermal comfort within the passenger compartment,
a criterion relating to electrical energy consumption on board the vehicle and used for the operation of said at least one actuator,
a criterion relating to a carbon dioxide level within the passenger compartment,
a criterion relating to a noise level within the passenger compartment.

According to a second aspect, the invention relates to a computer program including instructions for implementing a regulating method according to the invention when said program is executed by a computer.

This program can use any programming language, and be in the form of source code, object code, or intermediate code between source code and object code, such as in a partially compiled form, or in any other desirable form.

According to a third aspect, the invention relates to a computer-readable information or recording medium on which a computer program according to the invention is recorded.

The information or recording medium may be any entity or device capable of storing the program. For example, the medium may include a storage means, such as a ROM, for example a CD-ROM or a microelectronic circuit ROM, or a recording means, for example a USB key or a hard disk.

On the other hand, the information or recording medium may be a transmissible medium such as an electrical or optical signal, which can be conveyed via an electrical or optical cable, by radio or by other means. The program according to the invention may in particular be downloaded over a network of the Internet type.

Alternatively, the information or recording medium may be an integrated circuit wherein the program is incorporated, the circuit being adapted to execute or to be used in the execution of the method in question.

According to a fourth aspect, the invention relates to a system for regulating the presence of condensation on at least one glazed unit of a vehicle. Said system includes means configured to implement a regulating method according to the invention.

According to a fifth aspect, the invention relates to a vehicle including a system for regulation according to the invention.

In particular embodiments, said vehicle includes at least one electric motor to run on.

### BRIEF DESCRIPTION OF THE DRAWINGS

Other features and advantages of the present invention will emerge from the non-limiting description given below, with reference to the appended drawings that illustrate an exemplary embodiment thereof. In the Figures:

FIG. 1 schematically shows, in its environment, a particular embodiment of a regulation system according to the invention, said regulation system being configured to regulate the presence of condensation on the windshield of a vehicle;

FIG. 2 schematically shows an example hardware architecture of the regulation system of FIG. 1;

FIG. 3 schematically shows a particular operating mode of a control loop implemented by the control system of FIG. 1 to regulate the presence of condensation;

FIG. 4 shows, in flowchart form, a particular embodiment of a control method incorporating the control loop of FIG. 3;

FIG. 5 schematically shows a particular embodiment of a regulation module belonging to the regulation system of FIG. 1 and used for the operation of the control loop of FIG. 3;

FIG. 6 shows another particular embodiment of the control loop;

FIG. 7 shows, in flowchart form, a particular embodiment of the regulating method incorporating the control loop of FIG. 6.

### DESCRIPTION OF EMBODIMENTS

The present invention belongs to the field of managing the state of one or more glazed units of a vehicle, and more specifically targets the regulation (i.e. the control) of the risk of moisture condensation (i.e. of the risk of condensation) on one or more glazed units of said vehicle.

The remainder of the description relates more particularly to a vehicle of the electric car type. “Electric car” refers here to a car that includes at least one electric motor and which, in order to run (i.e. to operate said at least one electric motor), uses only the electrical energy on board one or more batteries that equip it.

For reasons of simplification of the description, it is also considered in a non-limiting fashion that the regulation mentioned above applies only to the windshield of said electric car.

It is important, however, to note that the present invention is not limited to the case of an electric car, and may equally relate to a hybrid car or else a car only equipped with a combustion engine.

More generally, considering a vehicle of the car type does not constitute a limitation of the invention, which remains applicable for any type of vehicle capable of moving by means of an on-board energy (electrical energy and/or fuel), such as a truck, a bus, a train, etc. and including at least one glazed unit.

In addition, describing the invention here merely in terms of the windshield of the electric car constitutes only one alternative embodiment of the invention. Thus, no limitation is attached to these aspects, so that other glazed units can be considered, such as for example a side window or a rear window of a car. Furthermore, nothing precludes considering a regulation of the presence of condensation for a plurality of glazed units.

Ultimately, regardless of the type of vehicle considered and regardless of the type and number of glazed units considered, the person skilled in the art knows how to adapt the following description without difficulty.

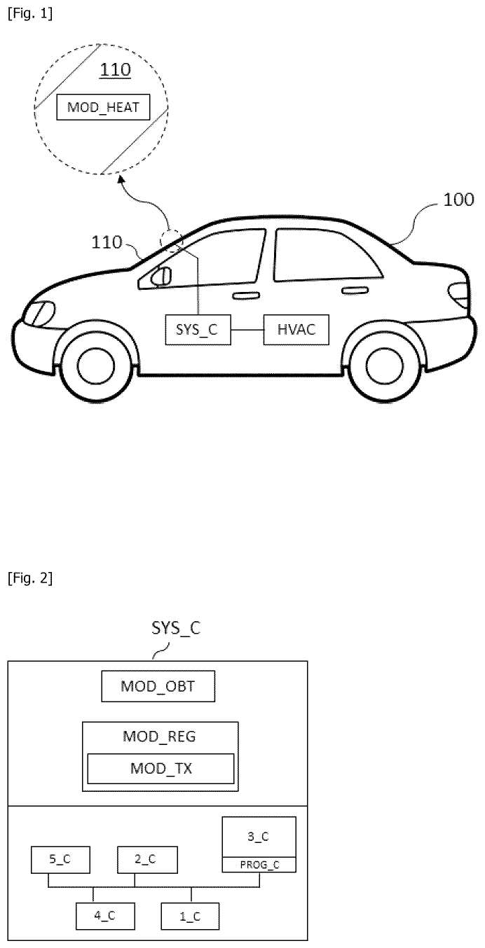

FIG. 1 schematically shows, in its environment, a particular embodiment of a system SYS_C for regulating the presence of condensation on the windshield 110 of the electric car 100.

In the embodiment of FIG. 1, the regulation system SYS_C is connected, via communication means described in more detail later, to an HVAC (which stands for “Heating, Ventilation and Air Conditioning”) system equipping the electric car 100.

Conventionally, said HVAC system is configured to heat, cool and ventilate the passenger compartment of the vehicle equipping the electric car 100. The design and implementation details of such an HVAC system being well known to a person skilled in the art, they are not repeated here.

Moreover, in the embodiment described here, in order to carry out the control of the defogging of the windshield 110, said system SYS_C is also connected to heating means MOD_HEAT equipping the windshield 110.

Said heating means MOD_HEAT comprise for example an array of electrical wires incorporated into the windshield 110 (case of a laminated glazed unit comprising a layer wherein said electrical wires are inserted). In general, all known heating means can be envisaged, this aspect not being limiting for the invention.

The regulation of the presence of condensation on the windshield 110 of the electric car 100 is therefore carried out, in the embodiment described here, by said heating means MOD_HEAT as well as by said air conditioning system HVAC. It is important, however, that such provisions are not limiting for the invention, only said heating means MOD_HEAT (respectively only said air conditioning system HVAC) being able for example to be used to regulate the presence of condensation on the windshield 110.

Thus, said heating means MOD_HEAT form actuators with respect to the planned regulation. The same applies to the component(s) of the air conditioning system HVAC that can be enlisted in the implementation of this regulation, such as for example: a fan and/or a compressor and/or a heating resistor (such as a heating resistor equipping a heating seat or a radiant panel of the car 100) and/or an air recirculation flap, etc.

In accordance with the invention, the system SYS_C is configured to perform processing operations making it possible to regulate (i.e. control) the presence of condensation on the inner surface of the windshield 110 of the electric car 100 (i.e. the surface in direct contact with the interior environment of the car 100, i.e. the passenger compartment of the car 100). In other words, said system SYS_C is configured to generate regulation commands intended for the heating means MOD_HEAT as well as for the air conditioning system HVAC, by implementing a regulating method according to the invention, described in detail below and the steps of which are included in a (closed) control loop.

The implementation of this regulating method, via said regulation system SYS_C, advantageously makes it possible to finely control the risk of condensation, and therefore the presence of condensation, on the windshield 110 of the electric car 100, so as to guarantee excellent driving comfort, in particular with regard to safety requirements related to visibility through said windshield 110.

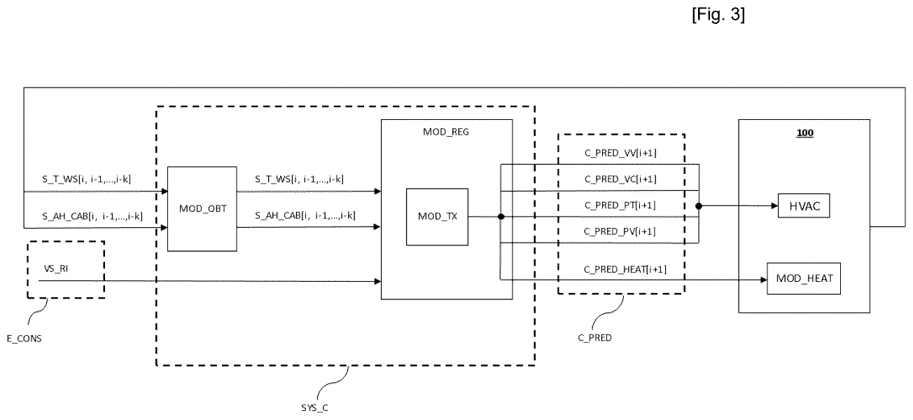

FIG. 2 schematically shows an example hardware architecture of the regulation system SYS_C of FIG. 1.

As shown in FIG. 2, the regulation system SYS_C according to the invention has the hardware architecture of a computer. Thus, said regulation system SYS_C includes, in particular, a processor 1_C, a random access memory 2_C, a read-only memory 3_C and a non-volatile memory 4_C. It also has communication means 5_C.

The read-only memory 3_C of the regulation system SYS_C constitutes a recording medium according to the invention, readable by the processor 1_C and on which a computer program PROG_C in accordance with the invention is recorded, including instructions for the execution of steps of the regulating method according to the invention. The program PROG_C defines functional modules of the regulation system SYS_C, which rely or control the previously mentioned hardware elements 1_C to 5_C, and which comprise in particular:
an obtaining module MOD_OBT configured to obtain at least one signal, referred to as a “control signal”, associated with a quantity and including past values and a current value of said quantity, a risk RI of moisture condensation on the inner surface of the glazed unit 110 that may be determined from said at least one quantity,
a regulation module MOD_REG configured to determine a predictive command C_PRED of the actuators of said heating means MOD_HEAT and of said air conditioning system HVAC, so as to maintain or lower said risk RI below a threshold value VS_RI, said command being determined by means of a predictive model MODEL of said risk RI,
a transmission module MOD_TX configured to transmit the predictive command C_PRED to said actuators.

In a known manner, the phenomenon of condensation on the windshield 110 may occur when any of the statements below is fulfilled:
the relative humidity reaches 100% in the vicinity of the windshield 110;
the temperature of the air in the vicinity of the windshield 110 reaches the dew point;
the partial pressure of water in the vicinity of the windshield 110 reaches the saturation vapor pressure.

These three statements are equivalent in that they each reflect the fact that if the mass of the water present in the passenger compartment of the car 100 in the vicinity of the windshield 110 is greater than what the air can contain in the form of steam in that vicinity, then condensation may appear on the inner surface of the windshield 110.

It follows from these considerations, and more particularly the equivalence between said statements, that it is possible to define the condensation risk RI as a function of different sets of physical quantities (a set potentially referring to one or more quantities), which then affects various embodiments of the invention with respect to the control signals intended to be obtained via said obtaining module MOD_OBT.

The control signals are for example associated with controllable quantities, i.e. quantities on which it is possible to act. In particular, for example, a signal associated with a quantity relating to a temperature outside the car does not form a control signal.

Also, in the embodiment described here, it is considered that two control signals are obtained (it being understood that each control signal is representative of a single quantity), which are:
a signal S_T_WS, the associated quantity of which is a temperature T_WS of the windshield 110. It should be noted that “temperature T_WS of the windshield 110” refers, for the present embodiment, to a temperature at the inner surface of the windshield 110,
a signal S_AH_CAB whose associated quantity is an absolute humidity AH_CAB within the passenger compartment of the car 100. In a manner known per se, the absolute humidity AH_CAB corresponds to the proportion by weight of water vapor present in the air contained in said vicinity of the windshield 110.

From said two control signals S_T_WS, S_AH_CAB, and on the basis of calculations known to the person skilled in the art, it is possible to determine (i.e. estimate), initially, a dew point DP_CAB of the passenger compartment of the car 100 (i.e. the temperature below which the water vapor contained in the passenger compartment condenses on surfaces, by the saturation effect).

Therefore, and in a second step, the risk RI of moisture condensation on the inner surface of the windshield 110 can be evaluated by considering a risk indicator I1_RI equal to the difference between the quantities T_WS and DP_CAB (i.e. I1_RI=T_WS-DP_CAB). More particularly, it is considered for example that:
if I1_RI is less than a first value T_INF, the risk RI is equal to 100%;
if I1_RI is greater than a second value T_SUP (T_SUP being greater than T_INF), the risk RI is zero;
if I1_RI is comprised between T_INF and T_SUP (i.e. T_INF<I1_RI<T_SUP), the risk RI is expressed as follows:

$$RI = A \times {( \frac{I1\_RI - T\_INF}{T\_SUP - T\_INF} )}^{n} \qquad [ Math 1 ]$$

wherein A and n are two given coefficients.

It should be noted that no limitation is attached to the choice of the parameters T_INF, T_SUP, A and n. In practice, these parameters are traditionally fixed during the manufacture of the car 100.

Moreover, considering such an RI value, when said indicator I1_RI is comprised between T_INF and T_SUP, constitutes only one alternative embodiment of the invention. Any other alternative known to the person skilled in the art can be used here when it is considered that the risk RI is determined from said risk indicator I1_RI.

More generally, it should be noted that taking into account said two control signals S_T_WS, S_AH_CAB to determine the risk RI, and therefore ultimately to implement the regulation, is not limiting of the invention.

Indeed, nothing precludes, for example, considering other embodiments wherein a single control signal is obtained by the obtaining module MOD_OBT, namely, for example, a signal S_RH_CAB whose associated quantity is a relative humidity RH_CAB inside the car 100 in the vicinity of the windshield 110 (typically at a distance from the windshield 110 less than or equal to 10 mm). From said signal S_RH_CAB, the risk RI of moisture condensation on the inner surface of the windshield 110 can be evaluated by considering a risk indicator I2_RI equal to said quantity RH_CAB. More particularly, it is considered for example that:
if I2_RI is greater than a first value RH_SUP, the risk RI is equal to 100%;
if I2_RI is less than a second value RH_INF (RH_SUP being greater than RH_INF), the risk RI is zero;
if I2_RI is comprised between RH_INF and RH_SUP (i.e. RH_INF<I2_RI<RH_SUP), the risk RI is expressed as follows:

$$RI = {A}^{′} \times {( \frac{I2\_RI - RH\_INF}{RH\_SUP - RH\_INF} )}^{{n}^{′}} \qquad [ Math 2 ]$$

wherein A′ and n′ are two given coefficients.

According to considerations similar to those mentioned above, no limitation is attached to the choice of the parameters RH_INF, RH_SUP, A′ and n′, which are traditionally set during the manufacture of the car 100. What is more, considering such an RI value, when said indicator I2_RI is comprised between RH_INF and RH_SUP, constitutes only one alternative embodiment of the invention, any other alternative known to the person skilled in the art being usable here when it is considered that the risk RI is determined from said risk indicator I2_RI.

With respect to the threshold value VS_RI, that value may either be constant, or be variable over time, no limitation being attached to this aspect. As a general rule, and as considered in the embodiment described herein, it is a constant value that is fixed (for example during the construction of the car 100), stored in the non-volatile memory 4_C, and playing a role of a threshold beyond which it is considered that condensation is likely to appear on the windshield 110.

In other words, it is possible to consider this threshold value VS_RI as an operating constraint of the regulation system SYS_C. For the remainder of the description, the notation is adopted whereby the operating constraint(s) of the regulation system SYS_C form(s) a set of constraints denoted “E_CONS”.

Within the meaning of the present invention, the expression “predictive command C_PRED” refers to a command of the proactive compensation/correction type aiming to activate/deactivate the heating means MOD_HEAT and/or activate/deactivate at least one component belonging to the air conditioning system HVAC so as to regulate the presence of condensation on the windshield 110. Such a predictive command relates to an advanced automatic command technique (the acronyms “MPC” or “MBPC” are commonly used to refer to this technique, and stand for “Model (Based) Predictive Control”).

The general principle of this MPC technique consists of using at least one model powered by signals. Said at least one model makes it possible to describe the change in one or more quantities within the passenger compartment of the car 100, including in particular the quantities associated with the signals supplied to it at the input, in order to anticipate the future changes in the quantities in question, and thus to provide the commands which are the most appropriate to transmit to the actuators based on this change.

In this respect, and as already mentioned above, the model considered for the determination of the predictive command C_PRED is said predictive model MODEL using in particular the control signals S_T_WS, S_AH_CAB. More particularly, in the embodiment described here, it is considered that the predictive model MODEL includes:
a first sub-model SS_MODEL_CAB configured to model the change in temperature and humidity conditions (therefore in particular to model the change in the quantities T_WS and AH_CAB) at the inner surface of the windshield 110. Said first sub-model SS_MODEL_CAB is therefore a hygrothermal model of the zone located in the vicinity of the windshield 110 within the passenger compartment,
a second sub-model SS_MODEL_HVAC configured to model the change in temperature and humidity conditions within the passenger compartment of the vehicle due to the operation of an air conditioning system HVAC. For this purpose, said SS_MODEL_HVAC sub-model models and simulates the operation of the HVAC system components.

Any model (i.e. all of the equations, typically differential equations) able to model the change in temperature and humidity conditions at the inner surface of the windshield 110 (respectively able to model the change in temperature and humidity conditions within the passenger compartment of the vehicle due to the operation of an air conditioning system HVAC), and known to a person skilled in the art, can be used herein. In other words, the choice of a particular model, both for said first sub-model SS_MODEL_CAB and said second sub-model SS_MODEL_HVAC, constitutes only one alternative embodiment of the invention.

What is more, although it is considered here that the two sub-models SS_MODEL_CAB, SS_MODEL_HVAC are integrated into the predictive model MODEL, it should be noted that the presence of said second sub-model SS_MODEL_HVAC is, within the meaning of the invention, optional. Thus, nothing precludes considering other embodiments wherein only the first sub-model SS_MODEL_CAB is integrated into said predictive model MODEL (said first sub-model SS_MODEL_CAB is indeed the one responsible for modeling the change in the quantities associated with the control signals S_T_WS, S_AH, CAB).

In addition to the aspects related to the use of a predictive model, the implementation of an MPC technique also includes, conventionally, an optimization of a cost function F. Said cost function F is primarily aimed, within the scope of the present invention, at allowing the regulation of the presence of condensation on the windshield 110.

In practice, the cost function F is constructed so as to at least allow the evaluation of the impact of predictions of the quantities associated with the control signals S_T_WS, S_AH_CAB with respect to the variation in the condensation risk RI. To this end, the cost function F may include at least one term from:
a difference between the condensation risk RI and said threshold value VS_RI,
a rate of change in the condensation risk RI (“rate of change” refers to change over time).

Generally, theoretical foundations of the MPC technique are well known to a person skilled in the art, and are not repeated here. Furthermore, the way in which said predictive command C_PRED is determined by the regulation module MOD_REG is detailed subsequently through embodiments of the regulating method according to the invention.

However, it may already be noted that, in the embodiment described here, the predictive command C_PRED includes a plurality of components dedicated to the air conditioning system HVAC, namely:
a component C_PRED_VV for controlling the speed of a fan (i.e. a fan blowing air within the passenger compartment of the electric car 100),
a component C_PRED_VC for controlling the speed of a compressor (i.e. of the compressor incorporated, in a conventional manner, into the air conditioning system HVAC),
a component C_PRED_PT for controlling the power of a heating resistor (such as, for example, a heating resistor equipping a heating seat or a radiant panel of the car 100),
a component C_PRED_PV for controlling the angular position of an air recirculation flap.

In addition to said components dedicated to the air conditioning system HVAC, said command C_PRED includes, in the present embodiment, a component C_PRED_HEAT for controlling the heating means MOD_HEAT.

Of course, considering said plurality of components C_PRED_W, C_PRED_VC, C_PRED_PT, C_PRED_PV for the HVAC system constitutes only one alternative embodiment of the invention. Thus, nothing precludes considering only part of said components. In addition or alternatively, nothing precludes considering one or more other components associated with the HVAC system.

It is also possible to consider that at least one component dedicated to the HVAC system or to the heating means MOD_HEAT is a zero component. In other words, the invention covers modes whereby only the heating means MOD_HEAT (respectively only one or more components of the HVAC system) are activated by the predictive command C_PRED.

The communication means 5_C in particular allow the regulation system SYS_C to transmit the command C_PRED to the heating means MOD_HEAT as well as to the HVAC system (accordingly, the heating means MOD_HEAT and the HVAC system are equipped with communication means configured to receive the command component(s) C_PRED which are dedicated to them).

The communication means 5_C also allow the regulation system SYS_C to receive the control signals S_T_WS, S_A_CAB.

Consequently, in the embodiment described here, said communication means 5_C incorporate the obtaining module MOD_OBT as well as the transmission module MOD_TX. Furthermore, it is also considered that the transmission module MOD_TX is incorporated into the regulation module MOD_REG, it being understood that nothing precludes considering that it is external to said regulation module MOD_REG. Furthermore, nothing precludes considering embodiments wherein the obtaining module MOD_OBT is also integrated into the regulation module MOD_REG.

To implement these data exchanges, the communication means 5_C include for example a computer data bus capable of transmitting the command C_PRED as well as of receiving the control signals. According to another example, the communication means 5_C comprise a wired or wireless communication interface capable of implementing any suitable protocol known to a person skilled in the art (Ethernet, Wi-Fi, Bluetooth, 3G, 4G, 5G, etc.). In general, no limitation is attached to the way in which the command C_PRED is transmitted and whose control signals are obtained.

In the embodiment described here, the control signals S_T_WS, S_AH_CAB are obtained from measurements, these measurements being acquired by acquisition means (not shown in the figures) equipping the electric car 100. The measurements carried out to obtain the control signals S_T_WS, S_AH_CAB relate to the quantities T_WS, AH_CAB.

The acquisition means configured to acquire said measurements include, in a known manner, an acquisition chain comprising a sensor dedicated to the measurement of each of said quantities T_WS, AH_CAB. Each of these sensors forms a sensitive element configured to provide an electrical signal as a function of the changes in the physical quantity to which it is associated. Said acquisition chain for example also includes an acquisition card configured to process the electrical signal supplied by a sensor, for example by amplification and/or filtering. Said acquisition means may also comprise, at the output of the acquisition chain, an analog/digital converter configured to digitize a processed electrical signal.

In general, the configuration of such acquisition means is well known to the person skilled in the art and is therefore not described in further detail here. In particular, a person skilled in the art knows, on the one hand, to choose sensors suitable for measuring the quantities T_WS, AH_CAB, and on the other hand how to position them.

Furthermore, although it is considered here that the acquisition means are external to the regulation system SYS_C (i.e. the obtaining module MOD_OBT does not incorporate the acquisition means), nothing precludes considering, according to another alternative, opposite arrangements (i.e. the obtaining module MOD_OBT incorporates the acquisition means).

It should be noted that the invention is not limited to the case where the measurements carried out by the acquisition means directly relate to the quantities associated with the control signals. In particular, it is possible to envisage that at least some of the measurements relate to other quantities from which the control signals can be obtained, in which case those signals can also be qualified as synthesis signals.

By way of non-limiting example, temperature measurements can be acquired on the exterior surface of the windshield 110 (i.e. the surface in direct contact with the outside environment of the car 100). From these measurements, and using a model (of the type known per se) of the windshield 110 modeling the thermal conduction effects, the control signal S_T_WS can be obtained.

It is also important to note that acquiring measurements of the quantities T_WS, AH_CAB makes it possible to have access, according to calculations known to the person skilled in the art, to corresponding values of the quantity RH_CAB, and therefore ultimately to an estimate of the risk indicator I2_RI. The reverse also remains true (i.e. estimating I1_RI from measurements of the quantity RH_CAB). These considerations therefore again illustrate that the measurements carried out by the acquisition means can relate directly or indirectly to the quantities associated with the control signals obtained by the obtaining module MOD_OBT.

A particular operating mode of the control loop of the regulating method, as implemented in particular by means of the regulation system SYS_C of FIG. 2, will now be described. The description of this particular operating mode is carried out with reference to the block diagram of FIG. 3 which represents said control loop (i.e. the signals exchanged between the various functional modules of the regulation system SYS_C).

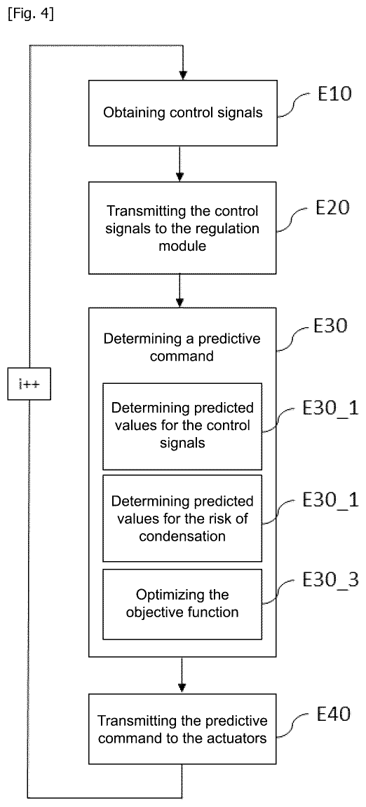

In parallel with the description of the operation of the control loop, we will also describe, with reference to FIG. 4, a particular embodiment of the regulating method.

As a reminder, in the mode described here, it is considered that the condensation risk RI is defined from the risk indicator I1_RI mentioned above.

For the description of FIGS. 3 and 4, a current iteration of the control loop is considered. This current iteration is indexed by means of the integer index “i” (as a result, the iteration that immediately follows the current iteration is indexed by the index “i+1”, and so on).

It is also considered that the control loop is iterated in a fixed period, for example a period of 1 second. However, it is noted that such a period of 1 second does not in any case constitute a limitation of the invention, and nothing precludes considering another period, such as for example a period of less than 1 second.

Also, for this current iteration, and as mentioned above, each control signal includes past values and a current value of the quantity associated with it. Thus, each control signal S_X (X potentially being T_WS or AH_CAB in the present embodiment) includes a component S_X[i] (current value) but also components S_X[i−1], . . . , S_X[i−k], where k is a determined integer defining the size of a history of past values. To designate the set of these current and past values S_X[i], S_X[i−1], . . . , S_X[i−k], the compact notation S_X[i, i−1, . . . , i−k] is again used.

It should be noted that taking into account past values for each of the control signals S_T_WS, S_AH_CAB is a conventional approach in the context of determining a predictive command. Furthermore, it will clearly be understood that these past values correspond to values which have been considered as current during previous iterations of the control loop. These past values are stored, as the control loop is iterated, by dedicated storage means (for example, non-volatile memory 4_C of the regulation system SYS_C, dedicated server external to the regulation system SYS_C, etc.).

As shown by FIG. 3, the control signals S_T_WS, S_AH_CAB are obtained (received) by the obtaining module MOD_OBT. This is the subject of step E10 of the regulating method, as shown in FIG. 4.

The control signals S_T_WS, S_AH_CAB thus obtained are then transmitted by the obtaining module MOD_OBT to the regulation module MOD_REG during one step E20 of the regulating method.

Upon receipt of said control signals S_T_WS, S_AH_CAB, and also from the threshold value VS_RI extracted from the non-volatile memory 4_C, the regulation module MOD_REG determines the predictive command C_PRED. This is the subject of step E30 of the regulating method, as shown in FIG. 4.

As a reminder, in the present embodiment, the predictive command C_PRED includes a plurality of components for the iteration of rank i+1, namely:
components C_PRED_W[i+1], C_PRED_VC[i+1], C_PRED_PT[i+1], C_PRED_PV[i+1] intended for the air conditioning system HVAC,
a component C_PRED_HEAT[i+1] intended for the heating means MOD_HEAT.

The predictive command C_PRED is then transmitted, by virtue of the transmission module MOD_TX, to the heating means MOD_HEAT as well as to the air conditioning system HVAC to regulate the risk of condensation on the windshield 110. This is the subject of step E40 of the regulating method, as shown in FIG. 4.

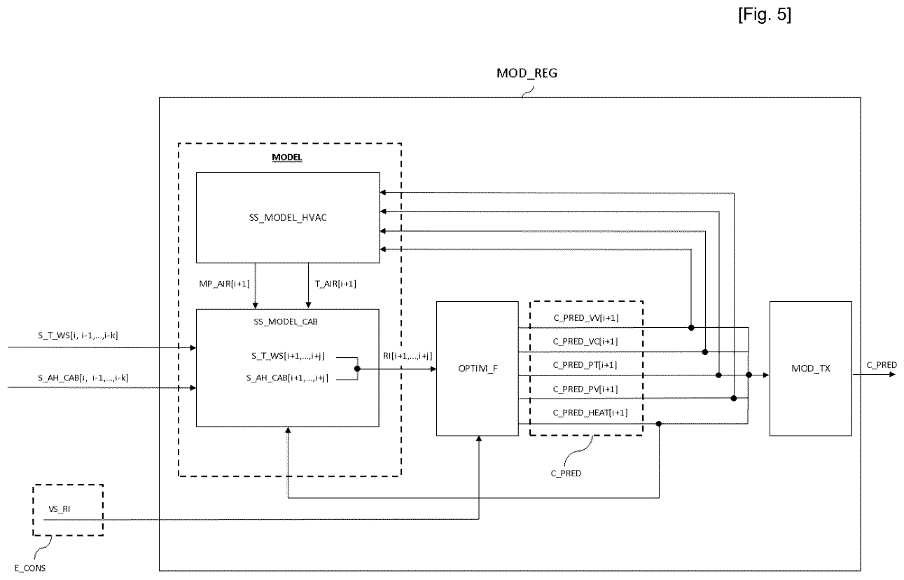

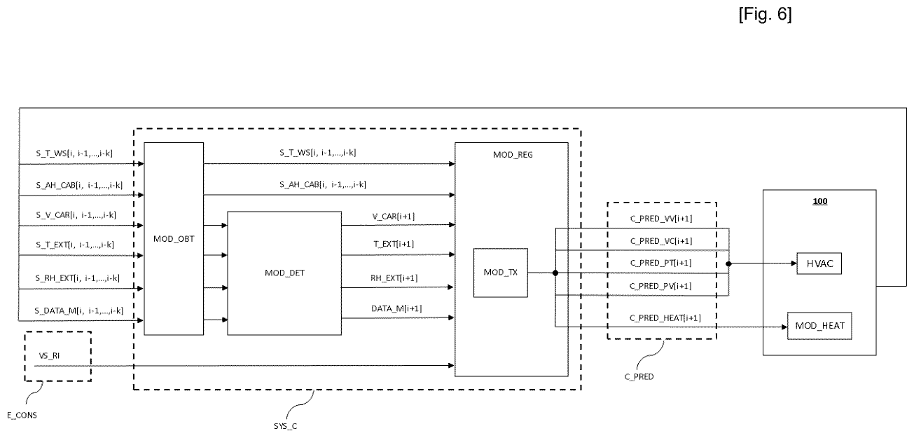

FIG. 5 is a more detailed schematic representation of the regulation module MOD_REG belonging to the regulation system SYS_C used for the operation of the control loop of FIG. 3. The implementation details of step E30, executed by the regulating module REG of FIG. 5, are also shown in FIG. 4.

As a reminder, we consider here in no way limiting that the predictive model MODEL used by the regulation module MOD_REG is formed by two sub-modules, namely said first and second sub-modules SS_MODEL_CAB, S_MODEL_HVAC.

As shown by FIG. 5, said sub-model SS_MODEL_CAB first receives at the input, following the execution of step 20, the control signals S_T_WS, S_AH_CAB.

The SS_MODEL_CAB sub-model then determines, during a sub-step E30_1 of step E30 of the regulating method, data S_T_WS[i+1], . . . , S_T_WS[i+j], as well as data S_AH_CAB[i+1], . . . , S_AH_CAB[i+j]. These data correspond to predicted values over a future time horizon of size j for each of the quantities T_WS, AH_CAB associated with said control signals S_T_WS, S_AH_CAB.

It should be noted that considering predictions of said quantities T_WS, AH_CAB over a future time horizon is a conventional approach in implementing an MPC technique. In addition, no limitation is attached to the size of said future time horizon (i.e. to the value of the integer j), which may be chosen according to considerations well known to the person skilled in the art (for example, time taken to execute the control loop, accuracy of the predictive command C_PRED, etc.).

From the data determined during sub-step E30_1, the sub-model SS_MODEL_CAB performs, in the implementation described here and for each time step m of the future time horizon (i.e. for each integer m comprised between i+1 and i+j):
a calculation of the risk indicator I1_RI[m],
a determination, based on the risk indicator I1_RI[m] calculated, of a associated condensation risk RI[m].

The condensation risk RI determined by the SS_MODEL_CAB sub-model therefore includes several components RI[i+1], . . . , RI[i+k], the calculation and determination steps described above for obtaining these components being grouped in a sub-step E30_2 of step E30 of the regulating method.

The components RI[i+1], . . . , RI[i+k] (=RI[i+1, . . . , i+j] in FIG. 5), as well as the threshold value VS_RI of the set of constraints E_CONS, are then used to perform the optimization of the cost function F. This optimization is subject to a sub-step E30_3 of step E30 of the regulating method, as shown by FIG. 4, and is also symbolically represented by means of a functional block referenced “OPTIM_F” in FIG. 5 (such a block with a solver function for the cost function F).

Any optimization algorithm known to the person skilled in the art can be implemented here, and the choice of a particular optimization algorithm constitutes only one alternative embodiment of the invention.

It should be noted that the optimization of the cost function F can be carried out by also taking into account the data provided by the sub-model SS_MODEL_HVAC, such as for example a data relating to the electrical energy consumed by the components of the HVAC system for which the predictive command C_PRED is, at least partly, intended. Such arrangements are schematically represented in FIG. 5 by means of an arrow connecting said sub-model SS_MODEL_HVAC to the block OPM_F.

In practice, stopping the optimization algorithm of the cost function F is contingent on a stop criterion. No limitation is attached to the nature of this stop criterion, which may for example correspond to a convergence criterion of the metric used by the cost function F (deviation between the condensation risk RI predicted by the predictive model and said threshold value VS_RI, rate of change of the condensation risk RI) and/or to a calculation time having reached a given threshold and/or to the reaching of a given number of iterations during which the best solution no longer changes.

The optimization of the cost function F ultimately makes it possible to generate a predictive command vector including as many components as the size j of the future time horizon used. In practice, only the first component of this vector (i.e. the component of rank i+1) is retained and corresponds to said predictive command C_PRED intended for the actuators.

It should be noted that the components of the predictive command C_PRED, apart from being transmitted to the heating means MOD_HEAT and the air conditioning system HVAC, can also be used to:
implement the calculations carried out by each of said sub-models SS_MODEL_CAB, SS_MODEL_HVAC, and/or
update parameters of each of said models SS_MODEL_CAB, SS_MODEL_HVAC.

To this end, and as shown by FIG. 5, the components C_PRED_VV[i+1], C_PRED_VC[i+1], C_PRED_PT[i+1], C_PRED_PV[i+1] are also transmitted to the sub-model SSMODEL_HVAC. The component C_PRED_HEAT[i+1] is also transmitted to the sub-model SS_MODEL_CAB.

Furthermore, once the components of the command C_PREP transmitted to said sub-models SS_MODEL_CAB, SS_MODEL_HVAC, additional data can be generated by said sub-model SS_MODEL_HVAC and transmitted to the sub-model SS_MODEL_CAB. By way of example, and as shown by FIG. 5, said additional data include an air flow rate value MP_AIR[i+1] of the air conditioning system HVAC, as well as a temperature value T_AIR[i+1] of the air injected into the passenger compartment by the air conditioning system HVAC. Such additional data advantageously allow the SS_MODEL_CAB sub-model to refine its predictions for the next iteration of the control loop.

The invention has been described until now with the assumption that the regulating method is implemented from the control signals alone (two control signals S_T_WS, S_AH, CAB or else a single control signal S_RH_CAB). However, the invention is not limited by such provisions, and in fact covers other embodiments wherein still other signals, in addition to said control signals, are used for implementing the regulating method.

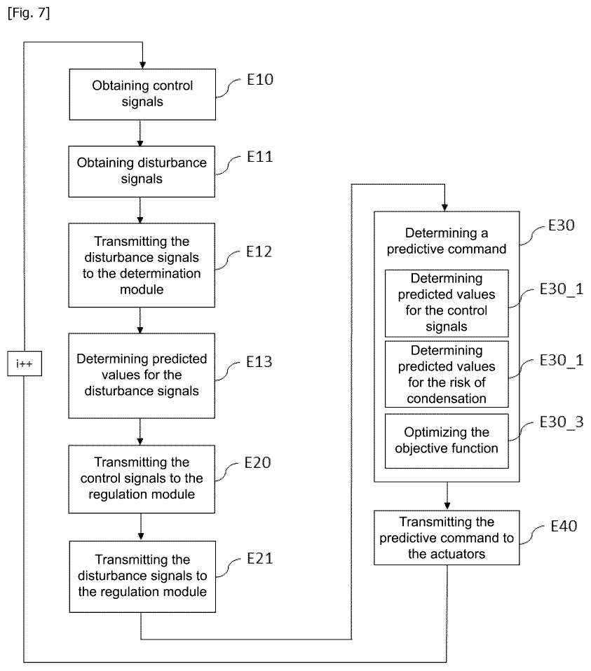

FIG. 6 schematically shows another particular operating mode of the control loop. FIG. 7 shows, in flowchart form, a particular embodiment of the regulating method incorporating the control loop of FIG. 6.

The steps of the regulating method of FIG. 7 comprise steps E10, E20, E30 and E40 already described above with reference to FIG. 4, but also, in non-limiting fashion, sub-steps E30_1, E30_2 and E30_3 described above with reference to FIG. 5.

In the embodiment of FIG. 6, the obtaining module MOD_OBT is configured to receive, in addition to the control signals S_T_WS, S_AH_CAB, a plurality of signals, called “disturbance signals”, including:
a signal S_V_CAR whose associated quantity is a speed V_CAR of the CAR 100,
a signal S_T_EXT whose associated quantity is an exterior temperature T_EXT outside the car 100,
a signal S_RH_EXT whose associated quantity is a relative humidity RH_EXT outside the car 100,
a signal S_DATA_M whose associated quantity is a weather prediction item of data M (rainfall, sunshine, etc.).

Similarly to what has been described for the control signals S_T_WS, S_AH, CAB, each disturbance signal S_V_CAR, S_T_EXT, S_RH_EXT, S_DATA_M includes past values and a current value of the quantity associated with it.

Obtaining said disturbance signals S_V_CAR, S_T_EXT, S_RH_EXT, S_DATA_M by the obtaining module MOD_OBT is the subject of a step E11 of the regulating method, as shown in FIG. 7. The order wherein steps E10 and E11 are implemented is not limiting on the invention. For example, steps E10 and E11 can be implemented in parallel.

It should be noted that considering said disturbance signals S_V_CAR, S_T_EXT, S_RH_EXT, S_DATA_M constitutes only one alternative embodiment of the invention. Thus, nothing precludes considering, in addition to or as a replacement for one or more of said signals S_V_CAR, S_T_EXT, S_RH_EXT, S_DATA_M, still other disturbance signals, such as for example:
a signal whose associated quantity is a number of persons in the vehicle,
a signal whose associated quantity is a carbon dioxide level present in the passenger compartment,
a signal whose associated quantity is an absolute humidity outside the car 100,
a signal whose associated quantity is a solar power absorbed by said at least one glazed unit and/or by the passenger compartment of the car 100.

Generally, no limitation is attached as to the number and nature of the disturbance signals that can be envisaged.

In the embodiment of FIG. 6, the regulation system SYS_C also includes a determination module MOD_DET configured to determine, from the disturbance signals S_V_CAR, S_T_EXT, S_RH_EXT, S_DATA_M, at least one predicted value for each of the quantities V_CAR, T_EXT, S_RH_EXT, DATA_M.

For example, and as shown by FIG. 6, the number of predicted values for each quantity V_CAR, T_EXT, S_RH_EXT, DATA_M is equal to j, that is the number of time steps considered for the future time horizon used by the regulation module MOD_REG during the determination of the predictive command C_PRED. However, nothing precludes considering a different number from j, for example less than j, for the predicted values for each of the quantities V_CAR, T_EXT, S_RH_EXT, DATA_M.

According to considerations similar to those mentioned above regarding the sub-models SS_MODEL_CAB, SS_MODEL_HVAC, any model (i.e. all of the equations, typically differential equations) able to model the change in the quantities V_CAR, T_EXT, S_RH_EXT, DATA_M, and known to the person skilled in the art, can be used here. In other words, the choice of a particular design constitutes only one alternative embodiment of the invention.

The determination of the predicted values for each of the quantities V_CAR, T_EXT, S_RH_EXT, DATA_M by the determination module MOD_DET is the subject of a step E13 of the regulating method, as shown by FIG. 7. This step E13 is executed after the disturbance signals S_V_CAR, S_T_EXT, S_RH_EXT, S_DATA_M are transmitted by the obtaining module MOD_OBT to the determination module MOD_DET, this transmission being the subject of a step E12 of the regulating method.

The predicted values for each of the quantities V_CAR, T_EXT, S_RH_EXT, DATA_M are in turn transmitted to the regulation module MOD_REG during a step E21 of the regulating method. The order wherein steps E20 and E21 are implemented is not limiting on the invention. For example, steps E20 and E21 can be implemented in parallel.

In the embodiment of FIG. 6, during the step E30 for determining the command C_PRED, the predictive model MODEL (more particularly here the sub-model SS_MODEL_CAB) uses, in addition to the control signals S_T_WS, S_AH_CAB, the predicted values for each of the quantities V_CAR, T_EXT, S_RH_EXT, DATA_M.

Taking into account the predicted values for each of the quantities V_CAR, T_EXT, S_RH_EXT, DATA_M advantageously makes it possible to refine (i.e. enrich) the models used for determining the predictive command C_PRED, and therefore a fortiori to further increase the regulation precision implemented.

The invention has also been described up to now with the assumption that the cost function F is optimized, during the determination of the predictive command C_PRED, by only taking into account the regulation of the presence of condensation on the windshield 110. However, the invention is not limited by such provisions, and in fact covers other embodiments wherein the cost function F can still take into account other aspects.

For example, the cost function F may comprise a weighting of at least one term representative of a criterion of use of the car 100. Said at least one usage criterion may comprise at least one of:
a criterion CRIT_1 relating to an absence of frost on the windshield 110,
a criterion CRIT_2 relating to thermal comfort within the passenger compartment,
a criterion CRIT_3 relating to electrical energy consumption on board the car 100 and used for the operation of the heating means MOD_HEAT and of the air conditioning system HVAC,
a criterion CRIT_4 relating to a carbon dioxide level within the passenger compartment,
a criterion CRIT_5 relating to a noise level within the passenger compartment (for example, noise generated by a fan of the air conditioning system HVAC, the noise level being therefore able to be modulated by modifying the speed of said fan).

No limitation is attached to the number of usage criteria (and therefore to the number of terms to be weighted) that can be considered among said criteria CRIT_p (p being an integer between 1 and 5). More generally, nothing excludes further considering one or more other usage criteria in addition or alternatively to all or part of the criteria CRIT_p.

Therefore, in such embodiments, the cost function F adopts a general formulation of the type F=F_D+F_CRIT, where:
F_D is a term representative of the contribution of only the regulation of the presence of condensation on the windshield 110 to the determination of the predictive command C_PRED,
F_CRIT is a term representative of the contribution of the usage criterion or criteria taken into account in determining the predictive command C_PRED.

Purely by way of illustration, the example whereby the usage criteria CRIT_2 and CRIT_3 are taken into account can be considered. As regards more specifically the criterion CRIT_2, it is considered that the comfort conditions relate not only to the temperature within the passenger compartment but also to absolute humidity within said passenger compartment. Therefore, the criterion CRIT_2 relates to thermal comfort within the passenger compartment.

In a manner known per se, the thermal comfort within the passenger compartment can be evaluated in various ways. In the example described here, it is considered in an entirely non-limiting way that the evaluation of thermal comfort is carried out by calculating a difference between a temperature T_CAB of said passenger compartment and a setpoint temperature T_CAB_SET selected by a user of the car 100 (for example, the driver of the car 100 sets the temperature T_CAB_SET to 20° C. within the passenger compartment). The obtaining of said setpoint temperature T_CAB_SET is carried out for example via said obtaining module MOD_OBT (for example, manual input interface integrated with said obtaining module MOD_OBT). What is more, the way in which the temperature T_CAB is regulated may not only depend on said setpoint T_CAB_SET but also, for example, a selection of an economical temperature control mode.

Other modes of evaluation of the thermal comfort can of course also be envisaged, such as for example an evaluation carried out by virtue of a Fanger model, also called a PMV/PPD model (which stands for “Predicted Mean Vote” and “Predicted Percentage of Disatisfied” in the literature). In general, no limitation is attached to the way in which thermal comfort is evaluated within the meaning of the present invention.

In the embodiment described herein, the weights of the usage criteria CRIT_2, CRIT_3 can be expressed as follows:

F_CRIT=w2*F_CRIT_2+w3*F_CRIT_3,
an expression wherein:
   w2 and w3 are weights (i.e. positive or zero real numbers),
   F_CRIT_2 is a term representative of the contribution of the usage criterion CRIT_2 to the term F_CRIT,
   F_CRIT_3 is a term representative of the contribution of the usage criterion CRIT_3 to the term F_CRIT.

It should be noted that the term “weights” covers all possible combinations between F_CRIT_2 and F_CRIT_3. In other words, nothing excludes considering the following alternatives:
weights w2 and w3 are both strictly positive, or
w2 (respectively w3) is strictly positive, w3 (respectively w2) being zero.

It may also be noted that taking into consideration one or more usage criterion in the cost function F has an impact in terms of signals intended to be obtained by the obtaining module MOD_OBT and/or of operating constraints of the regulation system SYS_C which should be taken into account at the optimizer OPM_F.

Thus, by taking the preceding example wherein the cost function F accepts for expression:

$$F = F\_D + w 2 * F\_CRIT \_ 2 + w 3 * F\_CRIT \_ 3 ,$$

it is understood that:
   for the criterion CRIT_2, the obtaining module MOD_OBT obtains not only, via appropriate measurements, a control signal S_T_CAB whose associated quantity is the temperature T_CAB of the passenger compartment, but also the value T_CAB_SET which constitutes a constraint belonging to the set of constraints E_CONS and which is provided at the input of the optimizer OPM_F,
   as regards the criterion CRIT_3, a signal S_ELEC representative of a maximum electrical power available for the operation of said heating means MOD_HEAT and of said air conditioning system HVAC, and belonging to the set of constraints E_CONS, is provided at the input of the optimizer OPM_F.

In general, for any usage criterion that can be taken into account in optimizing the cost function F, a person skilled in the art knows how to determine the quantity (ies) (and therefore a fortiori the associated signal(s)) as well as the constraint(s) intended to be taken into account.

Finally, the invention has also been described until now considering that the heating means MOD_HEAT and the air conditioning system HVAC are two entities external to the regulation system SYS_C. These arrangements are, however, not limiting for the invention, and nothing precludes considering embodiments wherein the heating means MOD_HEAT and/or the air conditioning system HVAC belong to the regulation system SYS_C.

1. A method for regulating the presence of condensation on an inner surface of at least one glazed unit of a vehicle, said method including a control loop comprising, during a current iteration, steps of:
obtaining at least one control signal, associated with a quantity and including past values and a current value of said quantity, a risk of moisture condensation on the inner surface of said at least one glazed unit that may be determined from said at least one quantity,
determining a predictive command for at least one actuator of the vehicle so as to maintain or lower said risk below a threshold value, said command being determined by means of a predictive model of said risk using said at least one control signal, and
transmitting the predictive command to said at least one actuator.

2. The method according to claim 1, wherein a plurality of control signals are obtained, including:
a signal whose associated quantity is a temperature of said at least one glazed unit, and
a signal whose associated quantity is an absolute humidity inside the vehicle in the vicinity of said at least one glazed unit.

3. The method according to claim 1, wherein a single control signal is obtained, the quantity associated with said control signal being a relative humidity inside the vehicle in the vicinity of said at least one glazed unit.

4. The method according to claim 1, wherein the determination of said condensation risk, for a given time interval of a future time horizon, includes:
obtaining a temperature of said at least one glazed unit and of a dew point of a passenger compartment,
calculating a gap between said temperature of said at least one glazed unit and said dew point of the passenger compartment,
comparing said gap with at least one given value.

5. The method according to claim 1, wherein the determination of said condensation risk, for a given time interval of a future time horizon, includes:
obtaining a relative humidity inside the vehicle in the vicinity of said at least one glazed unit,
comparing said relative humidity with at least one given value.

6. The method according to claim 1, wherein said at least one actuator includes means for heating said at least one glazed unit and/or at least one actuator of an air conditioning system of the passenger compartment of the vehicle from: a fan, a compressor, a heating resistor, an air recirculation flap.

7. The method according to claim 1, wherein the predictive model is configured to model:
a change in temperature and humidity conditions at the inner surface of said at least one glazed unit, and
a change in temperature and humidity conditions within the passenger compartment of the vehicle due to an operation of an air-conditioning system of said passenger compartment.

8. The method according to claim 1, said method also including a step of obtaining at least one disturbance signal, associated with a quantity and including past values and a current value of said quantity, said at least one disturbance signal being at least one of:
a signal whose associated quantity is a number of persons in the vehicle, a signal whose associated quantity is a carbon dioxide level present in the passenger compartment,
a signal whose associated quantity is a vehicle speed,
a signal whose associated quantity is a temperature outside the vehicle,
a signal whose associated quantity is a relative or absolute humidity outside the vehicle,
a signal whose associated quantity is a weather forecast item of data,
a signal whose associated quantity is a solar power absorbed by said at least one glazed unit and/or by the passenger compartment of the vehicle,
the method further including a step of determining, from said at least one disturbance signal, at least one predicted value of the quantity associated with said at least one disturbance signal,
the predictive model of said condensation risk also using said at least predicted value when determining the predictive command of said at least one actuator.

9. The method according to claim 1, wherein the step of determining the predictive command includes an optimization of a cost function including at least one term from:
a difference between the condensation risk predicted by the predictive model and said threshold value,
a rate of change in the condensation risk.

10. The method according to claim 9, wherein the cost function also includes a weighting of at least one term representative of a vehicle usage criterion, said at least one usage criterion including at least one of:
a criterion relating to an absence of frost on said at least one glazed unit,
a criterion relating to thermal comfort within the passenger compartment,
a criterion relating to electrical energy consumption on board the vehicle and used for the operation of said at least one actuator,
a criterion relating to a carbon dioxide level within the passenger compartment,
a criterion relating to a noise level within the passenger compartment.

11. (canceled)

12. A non-transitory computer-readable recording medium on which instructions for implementing a regulating method according to claim 1 are recorded.

13. A system for regulating the presence of condensation on at least one glazed unit of a vehicle, said system including means configured to implement a regulating method according to claim 1.

14. A vehicle including a system for regulating according to claim 12.

15. The vehicle according to claim 14, said vehicle including at least one electric motor to run on.
